(19) United States
(12) Patent Application Publication
(10) Pub. No.: US 2014/0331717 A1
(43) Pub. Date: Nov. 13, 2014

(54) PLATE GLASS PRODUCTION DEVICE, AND PLATE GLASS PRODUCTION METHOD

(71) Applicant: Asahi Glass Company, Limited, Tokyo (JP)

(72) Inventor: Motoichi IGA, Tokyo (JP)

(21) Appl. No.: 14/339,254

(22) Filed: Jul. 23, 2014

Related U.S. Application Data
(63) Continuation of application No. PCT/JP2013/050957, filed on Jan. 18, 2013.

(30) Foreign Application Priority Data
Feb. 8, 2012 (JP) 2012-024752

(51) Int. Cl. C03B 18/16; C03C 3/093; C03C 3/091

(52) U.S. Cl. CPC C03B 18/16; C03C 3/091; C03C 3/093
USPC 65/99.2; 65/182.5

(57) ABSTRACT

Provided is an apparatus for producing a sheet glass, including a bath for storing molten metal, the apparatus configured to form a glass ribbon by allowing molten glass that is continuously supplied on said molten metal to flow on said molten metal, in which said bath is formed of carbon or boron nitride.

### CROSS-REFERENCE TO RELATED APPLICATIONS

This application is a continuation application filed under 35 U.S.C. 111(a) claiming the benefit under 35 U.S.C. §§120 and 365(c) of PCT International Application No. PCT/JP2013/050957 filed on Jan. 18, 2013, which is based upon and claims the benefit of priority of Japanese Application No. 2012-024752 filed on Feb. 8, 2012, the entire contents of which are hereby incorporated by reference in their entireties.

### TECHNICAL FIELD

The present invention relates to an apparatus for producing a sheet glass and a method for producing a sheet glass.

### BACKGROUND OF THE INVENTION

An apparatus for producing a sheet glass, comprises a bath for storing molten metal (for example, molten tin), and in which molten glass that is continuously supplied on the molten metal is flowed on the molten metal to form a glass ribbon (see, for example, Patent Document 1). The formed glass ribbon is pulled upward obliquely from the molten metal and delivered to an annealing furnace. The glass ribbon annealed in the annealing furnace is cut by a cutting device into a shape of predetermined dimension, whereby the product sheet glass is obtained. The sheet glass may be polished.

### BACKGROUND ART DOCUMENT

### Patent Document

Patent Document 1: JP-A-2010-202507

### SUMMARY OF THE INVENTION

### Problems that the Invention is to Solve

The bath is formed in a box shape opened upward and includes a plurality of bricks. A heater for heating a glass ribbon or molten metal is provided above the bath. On the other hand, a cooler for cooling the entire bottom surface of the bath to a temperature not more than the melting point of the molten metal is provided below the bath so as to suppress outflow of the molten metal from a joint (gap) between bricks. Therefore, since the cooler removes the heat provided from the heater, the energy utilization efficiency is low.

The present invention has been made by taking into account the above-described problem, and an object of the present invention is to provide an apparatus for producing a sheet glass and a method for producing a sheet glass, where the energy utilization efficiency is high.

### Means for Solving the Problems

In order to solve the above-described problem, an object of the present invention is to provide an apparatus for producing a sheet glass, comprising a bath for storing molten metal, and the apparatus is configured to form a glass ribbon by allowing molten glass that is continuously supplied on the molten metal to flow on the molten metal, wherein the bath is formed of carbon or boron nitride.

In the apparatus for producing a sheet glass of the present invention, it is preferred that the bath is formed of carbon and at least a part of an exposed portion on a surface of the bath is covered with an anti-oxidation film.

In the apparatus for producing a sheet glass of the present invention, it is preferred that the apparatus further comprises a heat insulating member including a side wall portion surrounding sides of said bath and a bottom wall portion provided below said bath.

It is preferred that the apparatus further comprises a space-forming member which forms a space between a bottom wall portion of the bath and the bottom wall portion of the heat insulating member.

It is preferred that the apparatus further comprises a heat generator disposed in the space.

It is preferred that the apparatus further comprises an airtight case including a side wall portion surrounding sides of the heat insulating member and a bottom wall portion covering the bottom part of the heat insulating member.

Moreover, an another object of the present invention is to provide a method for producing a sheet glass, comprising a step of forming a glass ribbon by allowing molten glass that is continuously supplied on molten metal in a bath to flow on the molten metal, wherein the bath is formed of carbon or boron nitride.

In the method for producing a sheet glass of the present invention, it is preferred that the bath is formed of carbon and at least a part of an exposed portion on a surface of the bath is covered with an anti-oxidation film.

In the method for producing a sheet glass of the present invention, it is preferred that a heat insulating member including a side wall portion surrounding sides of the bath and a bottom wall portion provided below the bath is disposed outside the bath.

It is preferred that a space is formed between a bottom wall portion of the bath and the bottom wall portion of the heat insulating member.

It is preferred that a heat generator is disposed in the space.

It is preferred that an airtight case including a side wall portion surrounding sides of the heat insulating member and a bottom wall portion covering the bottom part of the heat insulating member is disposed outside the heat insulating member.

In the method for producing a sheet glass of the present invention, it is preferred that the sheet glass is composed of an alkali-free glass comprising, as represented by mass percentage on the basis of oxides: SiO₂: from 50 to 66%, Al₂O₃: from 10.5 to 24%, B₂O₃: from 0 to 12%, MgO: from 0 to 8%, CaO: from 0 to 14.5%, SrO: from 0 to 24%, BaO: from 0 to 13.5%, and ZrO₂: from 0 to 5%, wherein MgO+CaO+SrO+BaO is from 9 to 29.5%.

It is preferred that the sheet glass is composed of an alkali-free glass comprising, as represented by mass percentage on the basis of oxides: SiO₂: from 58 to 66%, Al₂O₃: from 15 to 22%, B₂O₃: from 5 to 12%, MgO: from 0 to 8%, CaO: from 0 to 9%, SrO: from 3 to 12.5%, and BaO: from 0 to 2%, wherein MgO+CaO+SrO+BaO is from 9 to 18%.

### Advantage of the Invention

According to the present invention, an apparatus for producing a sheet glass and a method for producing a sheet glass, where the energy utilization efficiency is high, are provided.

### BRIEF DESCRIPTION OF THE DRAWINGS

FIG. 1 is a cross-sectional view showing a part of the apparatus for producing a sheet glass according to one embodiment of the present invention.

FIG. 2 is a cross-sectional view showing a joining manner of adjacent bottom wall blocks with each other.

FIG. 3 is a cross-sectional view showing a joining manner of adjacent bottom wall blocks with each other in a first modified example.

FIG. 4 is a cross-sectional view showing a joining manner of adjacent bottom wall blocks with each other in a second modified example.

### MODE FOR CARRYING OUT THE INVENTION

The mode for carrying out the invention is described below by referring to the drawings. Incidentally, in the following drawings, the same or corresponding construction is denoted by the same or corresponding reference symbol, and its description is omitted. Also, in the description, the upstream side in the glass ribbon conveying direction is referred to as the upstream side, and the downstream side in the glass ribbon conveying direction is referred to as the downstream side.

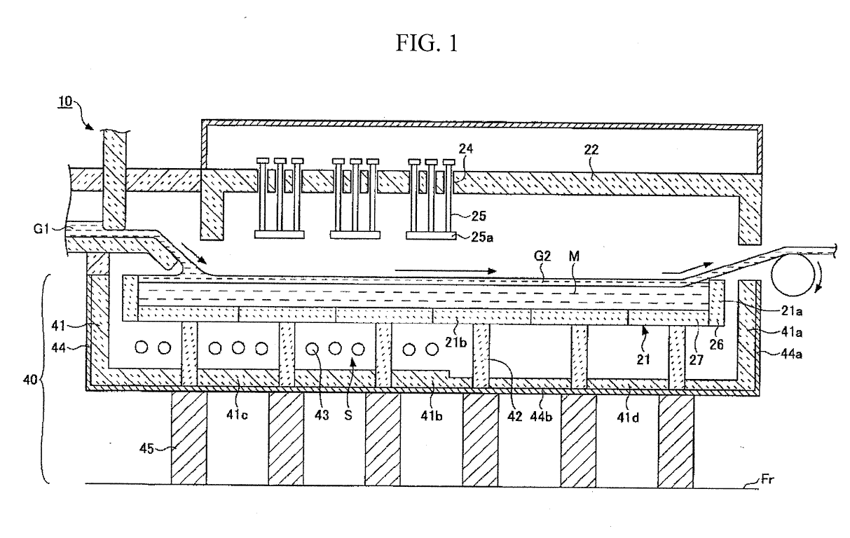

FIG. 1 is a cross-sectional view showing a part of the apparatus for producing a sheet glass according to one embodiment of the present invention.

The apparatus 10 for producing a plate glass has a bath 21 for storing molten metal (for example, molten tin) M, and molten glass G1 which is continuously supplied on the molten metal M is flowed on the molten metal M to form a glass ribbon G2. The formed glass ribbon G2 is pulled upward obliquely from the molten metal M and delivered to an annealing furnace. The glass ribbon annealed in the annealing furnace is cut by a cutting device into a shape of predetermined dimension, whereby the product sheet glass is obtained. The sheet glass may be polished.

The apparatus 10 for producing a plate glass further has a ceiling 22 covering the upper part above the bath 21. In the ceiling 22, a gas supply path 24 for supplying a reducing gas to a space between the ceiling 22 and the bath 21 is provided. In addition, a heater 25 is inserted into the gas supply path 24, and a heat-generating portion 25a of the heater 25 is disposed above the bath 21.

The gas supply path 24 supplies a reducing gas to a space between the bath 21 and the ceiling 22 so as to prevent oxidation of the molten metal M in the bath 21. The reducing gas contains, for example, from 1 to 15 vol % of hydrogen gas and from 85 to 99 vol % of nitrogen gas. The space between the bath 21 and the ceiling 22 is kept at an air pressure higher than the atmospheric pressure so as to prevent mixing of air from the outside.

A plurality of heaters 25 are arranged, for example, at intervals in the flow direction and width direction of the glass ribbon G2. The output of the heater 25 is controlled such that the temperature of the glass ribbon G2 gets higher closer to the upstream side in the flow direction of the glass ribbon G2. Also, the output of the heater 25 is controlled such that the thickness of the glass ribbon G2 becomes uniform in the width direction.

The apparatus 10 for producing a plate glass is characterized by the lower structure 40. The lower structure 40 of the apparatus 10 for producing a plate glass is described below. The lower structure 40 includes a bath 21, a heat insulating member 41, a space-forming member 42, a heat generator 43, a case 44, a supporting member 45.

### (Bath)

The bath 21 is in a box shape opened upward and includes a plurality of side wall blocks 26 and a plurality of bottom wall blocks 27. Each sidewall block 26 and each bottom wall block 27 are formed of carbon (including graphite and amorphous carbon) or boron nitride (BN).

In this way, the bath 21 is formed of carbon or boron nitride (BN) and therefore, exhibits low wettability to the molten metal M stored in the bath 21, as compared with a conventional bath formed of a brick. Thus, since the molten metal M can hardly flow out through the joint (gap) of the bath 21, a cooler for cooling the entire bottom surface of the bath 21 to a temperature not more than the melting point of the molten metal M is unnecessary. Thanks to this, the energy utilization efficiency is high.

In the case where the bath 21 is formed of carbon, in order to prevent a burned down of carbon, at least a part of the exposed portion (the portion not put into contact with the molten metal M) on the surface of the bath 21 may be covered with an anti-oxidation film. The anti-oxidation film may be a ceramic film such as silicon carbide (SiC) or silica (SiO₂). As the method for forming the anti-oxidation film, for example, a flame spraying method is used.

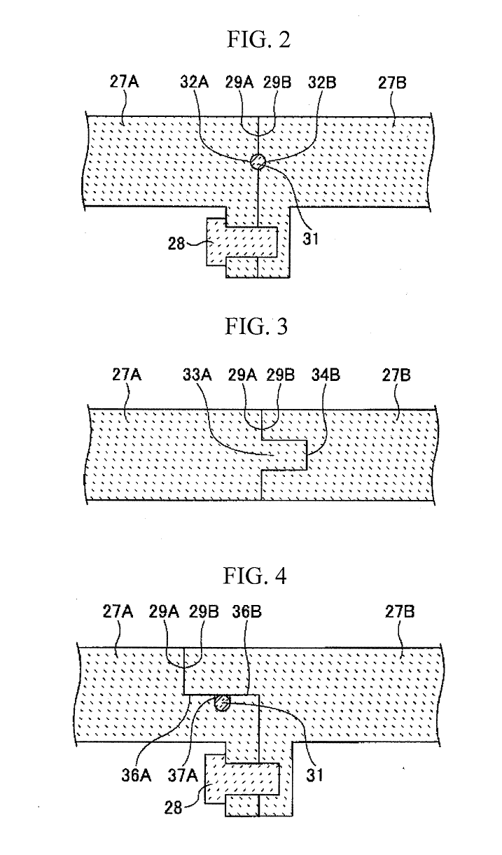

FIG. 2 is a cross-sectional view showing a joining manner of adjacent bottom wall blocks with each other. Incidentally, the joining manner of the bottom wall block 27 and the side wall block 26, which are adjacent to each other, is the same and therefore, illustration in the drawing is omitted.

The adjacent bottom wall blocks 27A and 27B may be joined by a bolt 28. The bold 28 penetrates one bottom wall block 27A and is screwed to the other bottom wall block 27B. The bolt 28 may be formed of the same carbon as the bottom wall blocks 27A and 27B.

Opposing surfaces 29A and 29B of the adjacent bottom wall blocks 27A and 27B each may be a vertical flat face and may be contacted with one another.

In order to unfailingly prevent outflow of the molten metal M, a heat-resistant seal member 31 for sealing the gap may be disposed between the adjacent bottom wall blocks 27A and 27B. The heat-resistant seal member 31 is formed of a material having high corrosion resistance against the molten metal M and may be formed of a material capable of deforming at the time of use. Specific examples thereof include glass that is softened at the working temperature. The heat-resistant seal member 31 may be supported by a groove portion 32A or 32B formed on at least one opposing surface 29A or 29B (in FIG. 2, on both surfaces) of the adjacent bottom wall blocks 27A and 27B.

### (Heat Insulating Member)

The heat insulating member 41 is disposed outside the bath 21. Unlike the bath 21, since the heat insulating member 41 does not come into contact with the molten metal M, corrosion resistance against the molten metal M is not required. As the material of the heat insulating member 41, for example, a fibrous heat insulating material such as ceramic or glass wool having low thermal conductivity can be used.

The heat insulating member 41 is in a box shape opened upward and includes an annular side wall portion 41a surrounding sides of the bath 21 and a bottom wall portion 41b disposed below the bath 21. In this way, the heat insulating member 41 is disposed outside the bath 21, whereby the bath 21 can be efficiently heated.

As for the thickness of the bottom wall portion 41b of the heat insulating member 41, the upstream portion 41c may be thick, and the downstream portion 41d may be thin. Since heat radiation proceeds in the downstream portion 41d, the flow distance of the glass ribbon G2 until the temperature of the glass ribbon G2 drops to a temperature enabling the pull-up from the molten metal M can be shortened.

### (Space-Forming Member)

The space-forming member 42 forms a space S between the bottom wall portion 21b of the bath 21 and the bottom wall portion 41b of the heat insulating member 41 so as to suppress thermal conduction from the bath 21 to the heat insulating member 41. Incidentally, the annular side wall portion 21a of the bath 21 is smaller than the annular side wall portion 41a of the heat insulating member 41, and a space is formed also between the side wall portion 21a of the bath 21 and the side wall portion 41a of the heat insulating member 41.

In the case where the heat insulating member 41 is formed of a fiber material and is soft, the space-forming member 42 may penetrate the heat insulating member 41 and be fixed to the bottom wall portion 44b of the case 44, as shown in FIG. 1. A plurality of space-forming members 42 may be provided at intervals. Incidentally, in the case where the heat insulating member 41 is a block-like sintered body and is hard, the space-forming member 42 may be disposed as a spacer between the bottom wall portion 41b of the heat insulating member 41 and the bottom wall portion 21b of the bath 21.

The space-forming member 42 receives the load of the bath 21 and at the same time, accepts the transfer of heat of the bath 21. For this reason, the space-forming member 42 is formed of a material having high load-resistant strength and high heat resistance (for example, silicon carbide or a heat-resistant alloy and the like). The space-forming member 42 may be formed of a plurality of kinds of materials, and, for example, while the upper portion of the space-forming member 42 is formed of silicon carbide, the lower portion of the space-forming member 42 may be formed of a heat-resistant alloy.

### (Heat Generator)

The heat generator 43 includes a heater or the like and is disposed in the space S between the bottom wall portion 21b of the bath 21 and the bottom wall portion 41b of the heat insulating member 41. The bath 21 can be efficiently heated from below.

A plurality of heat generators 43 may be arranged at intervals in the horizontal direction. The output of each heat generator 43 may be set to get higher closer to the downstream side.

### (Case)

The case 44 is in a box shape opened upward, is disposed outside the heat insulating member 41, and includes an annular side wall portion 44a surrounding sides of the heat insulating member 41 and a bottom wall portion 44b covering the bottom part of the heat insulating member 41. The case 44 has airtightness and prevents the molten metal M from oxidation due to infiltration of outside air. The case 44 is formed, for example, by weld-joining a plurality of metal sheets (stainless steel sheet, iron sheet, etc.). A heat insulating member 41 may be attached to the inner side of the case 44.

### (Supporting Member)

The supporting member 45 is a columnar member which is fixed to floor Fr and supports the case 44. Since the supporting member 45 is deprived of heat by the floor Fr, high heat resistance is not required. The supporting member 45 is composed of a material having high load-resistant strength. The material of the supporting member 45 includes, for example, stainless steel (SUS) and cast iron.

### (Method for Producing Sheet Glass)

The method for producing a sheet glass includes a step of, as shown in FIG. 1, forming a glass ribbon G2 by allowing molten glass G1 that is continuously supplied on molten metal (for example, molten tin) M in a bath 21 to flow on the molten metal M. The formed glass ribbon G2 is pulled upward obliquely from the molten metal M and delivered to an annealing furnace. The glass ribbon annealed in the annealing furnace is cut by a cutting device into a shape of predetermined dimension, whereby the product sheet glass is obtained. The sheet glass may be polished.

Since the bath 21 is formed of carbon or boron nitride, the bath 21exhibits low wettability to the molten metal M stored in the bath 21, as compared with a conventional bath formed of a brick. Thus, the molten metal M can hardly flow out through the joint of the bath 21, and a cooler for cooling the entire bottom surface of the bath 21 to a temperature not more than the melting point of the molten metal M is unnecessary. Thanks to this, the energy utilization efficiency is high.

A heat insulating member 41 including an annular side wall portion 41a surrounding sides of the bath 21 and a bottom wall portion 41b covering the lower part below the bath 21 may be disposed outside the bath 21 so as to suppress the outflow of heat. A space S may be formed between the bottom wall portion 21b of the bath 21 and the bottom wall portion 41b of the heat insulating member 41 so as to suppress thermal conduction from the bath 21 to the heat insulating member 41.

A heat generator 43 may be disposed in the space S. The bath 21 can be efficiently heated from below. A plurality of heat generators 43 may be arranged at intervals in the horizontal direction. The output of each heat generator 43 may be set to get higher closer the downstream side.

An airtight case 44 including an annular side wall portion 44a surrounding sides of the heat insulating member 41 and a bottom wall portion 44b covering the bottom part of the heat insulating member 41 may be disposed outside the heat insulating member 41 so as to prevent mixing of air (oxygen). Oxidation of the molten metal M can be suppressed. The case 44 is formed, for example, by weld-joining a plurality of metal sheets. A heat insulating member 41 may be attached to the inner side of the case 44.

### (Sheet Glass)

The kind of glass of the sheet glass is selected according to use of the sheet glass. For example, in the case of a glass substrate for LCD, an alkali-free glass is used. Moreover, in the case of a glass substrate for PDP and in the case of window glass for vehicles or window glass for buildings, a soda-lime glass is used. In the case of cover glass for display, an alkali silicate glass that can be chemically strengthened is mainly used. In the case of a substrate for photomask, quartz glass having a low coefficient of thermal expansion is mainly used.

The alkali-free glass, for example, comprises, as represented by mass percentage on the basis of oxides: SiO₂: from 50 to 66%, Al₂O₃: from 10.5 to 24%, B₂O₃: from 0 to 12%, MgO: from 0 to 8%, CaO: from 0 to 14.5%, SrO: from 0 to 24%, BaO: from 0 to 13.5%, and ZrO₂: from 0 to 5%, in which MgO+CaO+SrO+BaO is from 9 to 29.5%. In the alkali-free glass, the total content of an alkali metal oxide may be 0.1% or less.

The alkali-free glass preferably comprises, as represented by mass percentage on the basis of oxides: SiO₂: from 58 to 66%, Al₂O₃: from 15 to 22%, B₂O₃: from 5 to 12%, MgO: from 0 to 8%, CaO: from 0 to 9%, SrO: from 3 to 12.5%, and BaO: from 0 to 2%, in which MgO+CaO+SrO+BaO is from 9 to 18%.

The chemical composition of the sheet glass is measured by a commercially available fluorescent X-ray analyzer (for example, ZSX100e manufactured by Rigaku Corporation).

### FIRST MODIFIED EXAMPLE

While in the embodiment above, each of the opposing surfaces 29A and 29B of adjacent bottom wall blocks 27A and 27B is a vertical flat face, this modified example is different in that a convex is formed on one opposing surface and a concave is formed on another opposing surface. In the following, the difference is mainly described.

FIG. 3 is a cross-sectional view showing a joining manner of adjacent bottom wall blocks in the first modified example and is a view corresponding to FIG. 2.

As shown in FIG. 3, adjacent bottom wall blocks 27A and 27B may be joined by inserting a convex 33A formed on one opposing surface 29A into a concave 34B formed on another opposing surface 29B. In this modified example, the bolt 28 shown in FIG. 2 is unnecessary.

### SECOND MODIFIED EXAMPLE

While in the embodiment above, each of the opposing surfaces 29A and 29B of adjacent bottom wall blocks 27A and 27B is a vertical flat face, this modified example is different in that each of the opposing surfaces 29A and 29B has a horizontal portion. In the following, the difference is mainly described.

FIG. 4 is a cross-sectional view showing a joining manner of adjacent bottom wall blocks in the second modified example and is a view corresponding to FIG. 2.

Each of the opposing surfaces 29A and 29B of adjacent bottom wall blocks 27A and 27B may have a horizontal portion 36A or 36B. Outflow of the molten metal M due to gravity is slowed down between horizontal portions 36A and 36B opposing each other. In this case, the heat-resistant seal member 31 may be supported by a groove portion 37A formed on at least one of horizontal portions 36A and 36B.

While the present invention has been described in detail with reference to specific embodiments thereof, it will be apparent to one skilled in the art that various changes and modifications can be made therein without departing from the spirit and scope thereof.

This application is based on Japanese Patent Application No. 2012-024752 filed on Feb. 8, 2012, the contents of which are incorporated herein by reference.

### DESCRIPTION OF REFERENCE NUMERALS AND SIGNS

10 Apparatus for producing sheet glass
21 Bath
21a Side wall portion of bath
21b Bottom wall portion of bath
26 Side wall block
27 Bottom wall block
41 Heat insulating member
41a Side wall portion of heat insulating member
41b Bottom wall portion of heat insulating member
42 Space-forming member
43 Heat generator
44 Case
44a Side wall portion of case
44b Bottom wall portion of case
G1 Molten glass
G2 Glass ribbon
M Molten metal
S Space

1. An apparatus for producing a sheet glass, comprising a bath for storing molten metal, the apparatus configured to form a glass ribbon by allowing molten glass that is continuously supplied on said molten metal to flow on said molten metal,
wherein said bath is formed of carbon or boron nitride.

2. The apparatus for producing a sheet glass according to claim 1, wherein said bath is formed of carbon and at least a part of an exposed portion on a surface of said bath is covered with an anti-oxidation film.

3. The apparatus for producing a sheet glass according to claim 1, further comprising a heat insulating member including a side wall portion surrounding sides of said bath and a bottom wall portion provided below said bath.

4. The apparatus for producing a sheet glass according to claim 3, further comprising a space-forming member which forms a space between a bottom wall portion of the bath and said bottom wall portion of the heat insulating member.

5. The apparatus for producing a sheet glass according to claim 4, further comprising a heat generator disposed in said space.

6. The apparatus for producing a sheet glass according to claim 3, further comprising an airtight case including a side wall portion surrounding sides of said heat insulating member and a bottom wall portion covering the bottom part of said heat insulating member.

7. A method for producing a sheet glass, comprising a step of forming a glass ribbon by allowing molten glass that is continuously supplied on molten metal in a bath to flow on said molten metal,
wherein said bath is formed of carbon or boron nitride.

8. The method for producing a sheet glass according to claim 7, wherein said bath is formed of carbon and at least a part of an exposed portion on a surface of said bath is covered with an anti-oxidation film.

9. The method for producing a sheet glass according to claim 7, wherein a heat insulating member including a side wall portion surrounding sides of said bath and a bottom wall portion provided below said bath is disposed outside said bath.

10. The method for producing a sheet glass according to claim 9, wherein a space is formed between a bottom wall portion of said bath and the bottom wall portion of said heat insulating member.

11. The method for producing a sheet glass according to claim 10, wherein a heat generator is disposed in said space.

12. The method for producing a sheet glass according to claim 9, wherein an airtight case including a side wall portion surrounding sides of said heat insulating member and a bottom wall portion covering the bottom part of said heat insulating member is disposed outside said heat insulating member.

13. The method for producing a sheet glass according to claim 7, wherein said sheet glass is composed of an alkali-free glass comprising, as represented by mass percentage on the basis of oxides: SiO₂: from 50 to 66%, Al₂O₃: from 10.5 to 24%, B₂O₃: from 0 to 12%, MgO: from 0 to 8%, CaO: from 0 to 14.5%, SrO: from 0 to 24%, BaO: from 0 to 13.5%, and ZrO₂: from 0 to 5%, wherein MgO+CaO+SrO+BaO is from 9 to 29.5%.

14. The method for producing a sheet glass according to claim 13, wherein said sheet glass is composed of an alkali-free glass comprising, as represented by mass percentage on the basis of oxides: SiO₂: from 58 to 66%, Al₂O₃: from 15 to 22%, B₂O₃: from 5 to 12%, MgO: from 0 to 8%, CaO: from 0 to 9%, SrO: from 3 to 12.5%, and BaO: from 0 to 2%, wherein MgO+CaO+SrO+BaO is from 9 to 18%.
